(19) United States
(12) Patent Application Publication
(10) Pub. No.: US 2006/0098786 A1
(43) Pub. Date: May 11, 2006

(54) Method of determining the position of an object in an image

(76) Inventor: Kai Eck, Aachen (DE)

Correspondence Address: PHILIPS INTELLECTUAL PROPERTY & STANDARDS, P.O. BOX 3001, BRIARCLIFF MANOR, NY, 10510, US

(21) Appl. No.: 10/542,076

(22) PCT Filed: Dec. 16, 2003
(86) PCT No.: PCT/IB03/06324

§ 371 Date: Jul. 13, 2005

(30) Foreign Application Priority Data
Jan. 15, 2003 (EP) 03100075.5

(51) Int. Cl. H05G 1/28

(52) U.S. Cl. 378/163

(57) ABSTRACT

The invention relates to a method of determining the position of an object in an (X-ray) image (1). A pattern of marking elements is attached to the object., wherein the marking elements are not visibly evident individually in the image (I), i.e. they form an invisible “watermark”. By means of a correlation between the image (I) and a filter image (M) of the pattern of marking elements, however, the position of the marking elements, and thereby that of the object, can be localized in the image (I).

The invention relates to a method of determining the position of an object in an image, to marking means for application in a method of this kind, and to an X-ray system set up to implement the method.

Images of objects are generated in many different application areas and subsequently analyzed in respect of particular investigations. In analyses of this kind, it is frequently important to be able to localize the position of at least one object or of a particular site of an object on the image. The taking of medical X-ray images is considered below as an example to illustrate investigations of this kind. In order to execute a precise navigation of a catheter, for example, with the aid of X-ray images, or to relate various images from a sequence to one another with a high degree of accuracy (typically in the sub-mm range), it must be possible to localize the examination table and/or organs of the patient as precisely as possible on the X-ray images. It is true that, in principle, the position of the examination table relative to the X-ray apparatus can be detected by position sensors, such as potentiometers. However, the inaccuracy of these is generally much too great to enable the necessary pixel-precise localization of the table.

For a more precise determination of the positions of objects in X-ray images, therefore, a method is used in which X-ray-absorbent marking elements of known size, shape and absorption properties, which can be clearly recognized on the X-ray image, are attached to the examination table and/or the patient. However, the disadvantage of this is that the marking means distort the actual representation of the body. For this reason, they are generally used outside the observation field of interest, which leads in turn to a decrease in precision in the most important region of the image and to an enlargement of the area exposed to radiation.

In order to cover the image gaps caused by marking elements, it is known from WO 00/00086 for the sites of the marking means to be filled by an interpolation of the surrounding image content in a post-processing of the X-ray image. However, this can only succeed for marking elements that are small in size, and also carries the risk that image information that is not in fact present may be simulated at the sites of the marking means. In the case of semi-transparent marking elements, it is further known from WO 00/00086 for the absorption through the marking elements to be calculated subsequently in order to show the translucent image content in the area of the marking elements, undiminished and to best effect. Here again, however, a certain loss of image information at locations of weak exposure is unavoidable.

Against this background, it is an object of the present invention to provide means for determining the position of an object in an image, which means enable a precise localization of the object without impairment of the image.

This object is achieved by a method with the features as claimed in claim 1, by marking means with the features as claimed in claim 6 and by an X-ray system with the features as claimed in claim 9. Advantageous embodiments are contained in the dependent claims.

The method in accordance with the invention serves for determining the position of an object in an image. An image may be, in particular, an X-ray image, wherein the method is, however, not confined to this area, and also covers, for example, images generated by ultrasound, magnetic resonance, scintigraphy, photography or similar. It is characteristic of the method that a (coherent or fragmented) pattern of marking elements is attached to the object to be localized, wherein the marking elements are not visibly evident individually in the image. In this context, “not visibly” means that, during evaluation of the image, the marking elements, each considered per se, are not detectable or distinguishable from the remaining image content. In particular, they cannot be recognized when the image is visually evaluated by a human observer. This may be achieved by, for instance, making the marking elements small enough that they affect only one or just a few pixels. Additionally or alternatively, the difference brought about by a marking means at a location of the image from an image without marking means may be so small that it remains in the range of the background image noise. One individual image element cannot therefore be distinguished from the background noise of the image. In an X-ray image, for example, this may be achieved by marking means with very low absorption coefficients, which scarcely change the developing X-ray image.

With the proposed method, a “watermark”, which is invisible in standard image analysis and which does not distort or impair the normal image, is thereby introduced. The “watermark” may therefore be sited at any random location of the image, so that, in particular, an object in the part of the image of interest in the center can be marked and localized.

Whereas the individual marking element is not visible in the image and (without knowledge of the pattern) cannot be reliably localized, the pattern comprising multiple marking elements, which is assumed to be known, enables the common localization of all, or multiple, marking elements with the aid of suitable analysis methods. In accordance with a preferred embodiment, the position of the marking elements in the image is hereby determined by a correlation of the image with at least one so-called “filter image”, which represents the (fundamental) pattern of the marking elements. The filter image of the pattern has a maximum correlation with the image to be investigated when it lies precisely above the pattern of the marking elements concealed in the image. In other positions, on the other hand, the filter image will exhibit only a very much lower, randomly-related correlation. From the particular relative position between the image and the filter image that leads to a maximum correlation, the position of the marking elements and of the object to be localized can be determined in the image by means of the correlation method.

A bandpass filtration in the frequency range of the pattern is preferably undertaken before the correlation method in order to remove, as thoroughly as possible, the image components that are independent of the pattern.

In the correlation method described above, the filter image of the fundamental pattern may be transformed relative to the actual pattern (“original pattern”) of the marking elements, i.e. does not have to reflect this identically. In preferred transformations, the pattern is scaled, i.e. proportionately enlarged or reduced, rotated and/or distorted. Through the use of filter images which have been transformed relative to the original pattern of the marking elements, account may be taken of corresponding transformation of the original pattern when generating the image. For instance, with a conventional X-ray image, an original pattern of marking elements attached to the examination table parallel with the image sensor plane of the detector will be shown (slightly) enlarged in the image owing to the projection circumstances. The enlargement factor here depends on the geometry, in particular the distances between the X-ray source, the marking elements and the image sensor plane. This geometry will generally be known a priori with sufficient accuracy, so the associated scaling factor can be theoretically calculated and used for generating the filter image. If, however, the geometry is unknown or requires verification, the correlation method explained above may be undertaken with filter images of different scaling factors. The scaling that matches best will hereby show the largest value of the maximum correlation, so the geometry of the imaging configuration can also be determined in this manner. Similar considerations also apply to determination of general transformations, such as distortions of the original pattern that have arisen as a result of an oblique or freely curved position of the original pattern relative to the image sensor plane. Even these distortions can be identified by the filter image with the largest value of the maximum correlation.

The filter image of the pattern may be generated, by calculation, from the knowledge of the original pattern. It is, however, also conceivable for the filter image to be generated empirically by a separate picture of the marking means, wherein as few other objects as possible, or none at all, should be present in the area of the image and the imaging parameters must be selected in such a way that the marking elements can (exceptionally) be localized individually in this particular image.

In a preferred application area for the method, the image is generated by means of radioscopy, wherein the marking elements exhibit an absorption of the X-rays so low that the effect of this absorption lies within the noise level of the X-ray image. The individual marking element can therefore not be detected, either visually or with automatic analysis methods without knowledge of the original pattern. The normal image is therefore not impaired by the marking elements.

In accordance with a development of the method, the position of at least one further object is determined in the image in that a second pattern of marking elements, which, like the marking elements of the first pattern, do not show up individually in the image, is attached to the further object. The second pattern is, furthermore, different from the first pattern, so the first and second patterns, and thereby the objects marked hereby, can be distinguished from one another. In principle, a quasi-arbitrary number of different objects may be localized in this manner without visible distortions of the normal image occurring. A typical application example is that of the parallel localization of an examination table and of a patient lying on it in an X-ray image.

The invention further relates to a marking means provided for attaching to an object in order to determine its position in an image of the object (and, if applicable, of further objects). The marking means comprise marking elements arranged in a pattern, wherein the marking elements themselves are designed in such a way that they are not visibly evident individually in the image. The marking means are thereby suitable to be used in a method of the kind explained above. The advantages and variation options of the method are therefore appropriately assured for the marking means.

The marking elements are preferably applied to a transparent carrier, such as a foil, so that the pattern formed by them is fixed and the marking means can be handled as easily as possible. The “transparency” of the carrier hereby means, in a generalized sense, that it does not appear on the image to be generated, i.e. in the case of an X-ray image, for example, it exhibits an imperceptibly low absorption for X-radiation.

The pattern formed by the marking elements may be completely random provided that, on the basis of its pattern characteristic, it enables the subsequent, coordinated localization of the marking elements in an image. The pattern may, in principle, also be formed by a coherent area of touching or overlapping marking elements. However, the marking elements are preferably arranged in isolation from one another and distributed over a large surface in order to prevent distorting effects on the image and to ensure the greatest possible precision of the localization. It is especially preferred if the pattern of the marking elements shows a good correlation behavior in the sense that the correlation of the pattern with itself is high only when there is precise superimposition, and otherwise is low in all offset positions. A good correlation behavior of this kind is exhibited by, in particular, a two-dimensional maximum-length sequence. A maximum-length sequence is a binary sequence (i.e. only values 0 and 1 are possible) with a period 2^{r-}1 with rεN.

The invention further relates to an X-ray system comprising the following elements:

An X-ray source, which can preferably emit X-radiation conically.

An X-ray detector, which is disposed in the ray path of the X-ray source and is equipped with image sensors to measure the incident radiation dose.

At least one marking means for attachment to an object located between the X-ray source and the X-ray detector in order to determine its position in an X-ray image, wherein the marking means comprise marking elements arranged in a pattern, which are not visibly evident individually in the X-ray image.

A data processing unit for calculation of the position of the marking means in an image generated with the X-ray system.

For such a case of an X-ray image, the above-mentioned method can be implemented with an X-ray system of this kind. Therefore, the advantages of this method can also be achieved, i.e. an extremely accurate positional determination of objects in an X-ray image without any visible impairment of the X-ray image by marking elements.

The X-ray system is preferably of a design such that it can implement one or more variants of the method. For example, the data processing unit may be set up to calculate a correlation between the X-ray image and at least one filter image of the pattern of the marking elements, wherein the filter image may have been transformed relative to the original pattern of the marking elements. The marking elements may, furthermore, exhibit an absorption for X-radiation so low that their effect lies within the noise level of the X-ray image. The X-ray system may also comprise at least two marking means, which can be attached to different objects in the ray path of the X-ray source and which comprise different patterns of marking elements.

The invention will be further described with reference to examples of embodiments shown in the drawings, to which, however, the invention is not restricted.

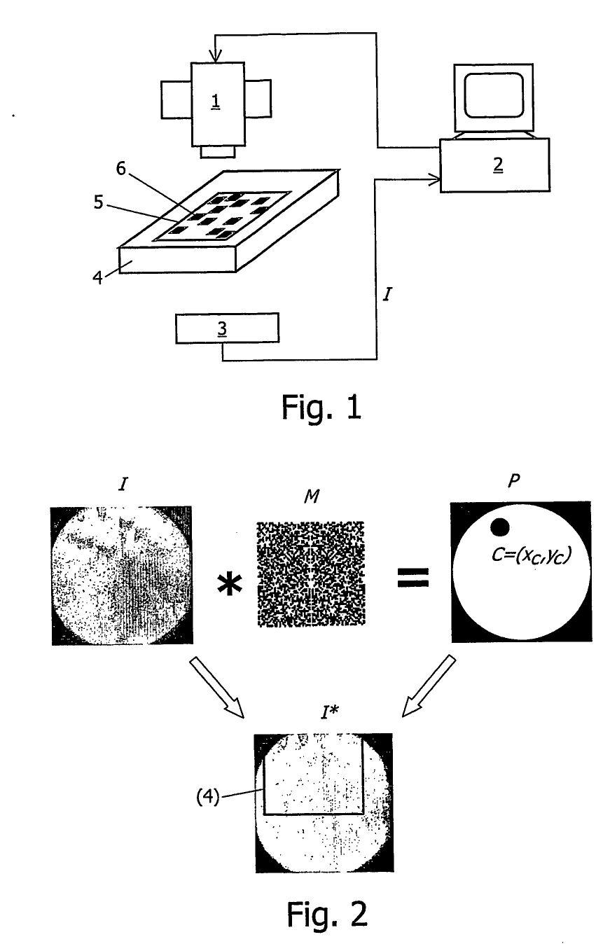

FIG. 1 shows an X-ray system set up for implementing the invention.

FIG. 2 shows the principle of positional determination of an object in an X-ray image generated with the X-ray system from FIG. 1.

The essential components of an X-ray system shown schematically in FIG. 1 comprise an X-ray source 1, opposite which an X-ray detector 3 with a detector surface comprising image sensors (not shown) is disposed . The X-ray source 1 and the X-ray detector 3 are generally disposed in a fixed relative-geometry on e.g. a C-arm (not shown). Also identifiable is a data processing unit 2, which is coupled with the X-ray source 1 and the X-ray detector 3 in order to drive these and in order to receive and further process X-ray images I taken by the X-ray detector 3. The data processing unit 2 is generally coupled with output devices, such as a monitor, in order to represent the X-ray image to a user. The X-ray system further comprises an examination table 4, on which a patient to be X-rayed (not shown) can lie.

If, for example, a catheter investigation is to be observed fluoroscopically with the X-ray system, X-ray images produced at various times have to be related to one another as accurately as possible. To this end, it must be possible to localize marked objects, such as the examination table 4 or points of the patient's body, on the various X-ray images with a high degree of accuracy.

Similar requirements also apply in the case of computer-tomographic X-ray images, in which the X-ray source 1 and the X-ray detector 3 rotate around the patient helically. In order to execute the intended three-dimensional reconstruction of the imaged body volume, it must be possible to relate the X-ray images taken from various directions to one another with pixel accuracy. The measurement accuracy of the sensors on the carriers of the X-ray source 1 and the X-ray detector 3, or on the investigation table 4, is, in the majority of cases, not adequate. For this reason, it is important to be able to identify marked points on the images themselves with a high degree of precision.

In order to fulfill the above-described requirements, the use of a special marking means 5 is provided in accordance with the invention. In the example in FIG. 1, the marking means 5 comprises a (virtually) X-ray-transparent (metallic) foil, which carries a pattern of “dot-shaped” marking elements 6, which are shown, greatly enlarged, in FIG. 1. The marking elements 6 preferably comprise a material extremely impervious to X-rays, such as copper or gold, with a small layer thickness. The marking elements 6 are therefore, regarded absolutely, only very slightly absorbent and mechanically flexible. They are also of a size that is as small as possible, which is preferably selected such that a marking element 6 approximately covers the area of an image sensor in the X-ray detector 3. The marking elements 6 therefore typically have a diameter in the range from approximately 100 μm to 1000 μm, wherein especially preferred is a diameter of approximately 150 μm.

Different methods come into consideration for producing the marking means 5. For instance, a Cu layer may firstly be applied to X-ray thin material, such as a polymethacrylate (“Plexiglas™”). The desired pattern of the marking elements can subsequently be formed in the Cu layer using lithographic methods, by thermal ablation (lasers etc.), or similar. Desired patterns may also be produced by stamping or boring out a carrier, by the vapor-deposition of substances onto a carrier or by a multiplicity of other methods.

By virtue of the shape, size, thickness and material selection of the marking element 6, the attenuation of the X-radiation is so small that it is concealed even under the most unfavorable conditions of system noise. The marking elements 6 are thereby not visibly evident on an X-ray image I.

As described below with reference to FIG. 2, the marking elements can, however, be localized in an X-ray image with the aid of suitable methods based on the knowledge of the pattern. A method of this kind starts from an X-ray image I, which has been created with the X-ray system of FIG. 1 and which contains the hidden pattern of marking elements as a “watermark”. Further stored in the data processing unit 2, which executes the method, is a filter image M, which reflects the fundamental original pattern of the marking elements 6 (i.e. without other objects). The filter image M may hereby identically replicate the original pattern of the marking elements 6, but may also contain it in scaled (enlarged or reduced), rotated or distorted form if corresponding transformations of the original pattern can be anticipated in the X-ray image I. The filter image M may, in particular, represent the original pattern in an enlargement that derives from the underlying imaging geometry of the X-ray system.

The pattern is preferably selected from the family of two-dimensional, cyclical binary maximum-length sequences (see K. D. Lüke, Korrelationssignale, (Correlation Signals), Springer-Verlag Berlin-Heidelberg, 1992, chapter 3.4), wherein the period of the sequence is half as great in each direction as the corresponding detector size in this direction, and wherein a “1” of the sequence indicates the presence, and a “0” of the sequence indicates the absence of a marking element. A (one-dimensional) maximum-length sequence Iₙ (nεN) is a binary sequence with a period 2^{r -}1 with rεN. A “two-dimensional maximum-length sequence” I_{n,m} (n, mεN) is defined in that, for each fixed n₀εN, the one-dimensional sequence Iₙ_{_{o,}}ₘ (mεN) is a one-dimensional maximum-length sequence and, conversely, for each fixed mₒεN, the one-dimensional sequence I_{n,m}_{ₒ}(nεN) is a one-dimensional maximum-length sequence. Patterns formed from maximum-length sequences exhibit an especially good correlation behavior, i.e. the correlation of the pattern with its copy is high given an identical position of the copy, whereas, in all mutually offset positions of the pattern and copy, it is considerably lower, and, for example, fluctuates around a low average value.

In addition to the maximum-length sequences, other sequences with good correlation behavior known from the relevant literature are, of course, especially suitable for the pattern formation. The sequences used for pattern formation do not necessarily have to be binary hereby. For example, trivalent, quadrivalent, quinquevalent or higher-value sequences may be simulated by marking elements of different “strengths” (i.e. degree of absorption). Technically, marking means of this kind may be realized by e.g. coating a carrier with a metal (Cu, Au etc.) with locally differing frequencies or thicknesses.

In order to localize the position of the original pattern of the marking elements in the X-ray image I, the X-ray image I is correlated, point by point, with the filter image M. For images constructed from pixels in matrix form, this operation can be expressed mathematically as follows:

$$P ( x , y ) = {\sum }_{{x}^{′} , {y}^{′}}^{} I ( {x}^{′} , {y}^{′} ) \cdot M ( {x}^{′} - x , {y}^{′} - y ) ∀ x , y$$

wherein I(x, y), M(x, y) and P(x, y) denote the pixel values of the X-ray image I, of the filter image M and of the calculated product image P in the pixel (x, y).

In every point (x, y) of the X-ray image I, the correlation between the filter image M and the X-ray image I yields a virtually identical (average) value. One important exception here, however, is the point C=(x_{c,} y_{c}), at which, during the correlation operation, the filter image M lies precisely above the X-ray image I in such a way that it coincides with the concealed pattern of the marking elements 6. In respect of the above formula, this means that one point (x′, y′) of the X-ray image I belongs to precisely one marking element 6 when (x′−x_{c}, y′−y_{c} belongs to the same marking element in the filter image M. In the case where the filter image M is in a position of this kind, a maximum correlation thereby arises between the original pattern and the pattern of the filter image M, which leads to a maximum value of the correlation sum P(x_{c}, y_{c}). In the image P, this point, which corresponds to the center C of the pattern, is thereby clearly detectable. The position of the marking elements in the X-ray image I can therefore also be determined via the position of this point C, as a result of which, in turn, the position of an object in fixed connection with the marking elements, such as the investigation table 4, can be identified. In accordance with FIG. 2, the localized object can then be shown highlighted in a new X-ray image I*.

Furthermore, the known position of the pattern of the marking elements 6 in the X-ray image I can also be used to calculate the known (weak) absorption of the marking elements 6 in order to minimize any image change resulting from the marking elements 6.

In accordance with a variant of the above method, a high-pass filtration is executed before and/or after the correlation. As a result, slowly varying components of the image, which may stem from the imaging of the actual object and may distort the positional determination of the original pattern, can be removed.

In principle, any (original) pattern whatever of marking elements 6 may be used for the method. In particular, a pattern may also contain information such as lettering and/or illustrations (e.g. a company logo). In the simplest case, this information may be imaged directly (geometrically) in the pattern. Preferably, however, it is implicitly implemented in the pattern in such a way that it is not identifiable until the post-processing. For instance, a pattern may be composed of the multiple superimposition of a shifted two-dimensional maximum-length sequence M. During the subsequent correlation of this composed pattern with the two-dimensional maximum-length sequence as the filter image M, a distinct point is always generated when the filter image M lies precisely above a maximum-length sequence contained in the pattern. With appropriate construction of the pattern, virtually any desired image can be composed from the points generated in this manner.

In many applications, it is necessary, additionally or alternatively to the positional determination of the examination table 4 shown in FIG. 1, to monitor any independent movement of the patient. In this case, a marking means is provided in the form of a foil with similar marking elements to the marking means 5 of the table, and this is secured to the patient's back. The various marking means preferably hereby exhibit different patterns. In particular, the two-dimensional maximum-length sequences of the various marking means may be selected from a family of orthogonal codes, so that the results of a mutual correlation do not interfere with each other.

1. A method of determining the position of an object in an image, wherein a pattern of marking elements, which are not visibly evident individually in the image, is attached to the object.

2. A method as claimed in claim 1, wherein the position of the marking elements in the image is determined by a correlation of the image with at least one filter image of the pattern of the marking elements.

3. A method as claimed in claim 2, wherein the filter image of the pattern is transformed relative to the actual pattern of the marking elements.

4. A method as claimed in claim 1, wherein the image is generated by means of radioscopy, and the marking elements exhibit a low absorption of the X-rays, the effect of which lies within the noise level of the X-ray image.

5. A method as claimed in claim 1, wherein the position of at least one further object is determined in the image, wherein a second pattern of marking elements, which do not show up individually in the image, is attached to the further object, and wherein the second pattern is different from the first pattern.

6. Marking means for attaching to an object in order to determine its position in an image, wherein the marking means comprise marking elements arranged in a pattern, which are not visibly evident individually in the image.

7. Marking means as claimed in claim 6, wherein the marking elements are applied to a transparent carrier.

8. Marking means as claimed in claim 6, wherein the pattern of marking elements 6 his a two-dimensional maximum-length sequence.

9. An X-ray system, comprising
an X-ray source generating a ray path;
an X-ray detector, which is disposed in the ray path of the X-ray source;
at least one marking means for attachment to an object in order to determine the position of the object in an X-ray image, wherein the marking means comprise marking elements, which are not visibly evident individually in the X-ray image.
a data processing unit for calculation of the position of the marking means in an image generated with the X-ray system.

10. An X-ray system as claimed in claim 9, wherein it is set up to implement a method as claimed in claim 1.

11. The X-ray system as claimed in claim 9, wherein said marking elements are arranged in a pattern.

12. The X-ray system as claimed in claim 9, wherein said pattern is a two dimensional, cyclical binary maximum length sequence.

13. The X-ray system as claimed in claim 9, wherein said marking elements are applied to a transparent carrier.
